(19) United States
(12) Patent Application Publication
(10) Pub. No.: US 2026/0161633 A1
(43) Pub. Date: Jun. 11, 2026

(54) INFORMATION ANALYSIS DEVICE, INFORMATION ANALYSIS METHOD, AND RECORDING MEDIUM

(71) Applicant: NEC Corporation, Tokyo (JP)

(72) Inventors: Mamoru SAITA, Tokyo (JP); Norio YAMAGAKI, Tokyo (JP); Shunichi KINOSHITA, Tokyo (JP); Hirofumi UEDA, Tokyo (JP)

(73) Assignee: NEC Corporation, Tokyo (JP)

(21) Appl. No.: 19/367,895

(22) Filed: Oct. 24, 2025

(30) Foreign Application Priority Data
Dec. 11, 2024 (JP) 2024-216519

(51) Int. Cl. G06F 16/23; G06F 21/57

(52) U.S. Cl. CPC G06F 16/2365; G06F 21/57; G06F 2221/034

(57) ABSTRACT

Whether the information indicated by a plurality of pieces of text data describing an information security-related event is consistent is determined. An acquisition unit acquires a plurality of pieces of text data describing an information security-related event; an analysis unit analyzes whether information indicated by the pieces of acquired text data is consistent by using information security-related knowledge information; and an output unit outputs information based on an analysis result as to whether the information indicated by the pieces of text data is consistent.

### TECHNICAL FIELD

The present disclosure relates to an information analysis device, an information analysis method, and a recording medium, and more particularly, to an information analysis device, an information analysis method, and a recording medium that analyze text data related to an information security-related event.

This application is based upon and claims the benefit of priority from Japanese patent application No. 2024-216519, filed on December 11, 2024, the disclosure of which is incorporated herein in its entirety by reference.

### BACKGROUND ART

Information security-related events (including accidents and incidents related to information security that were prevented before occurrence) such as information leakage from an information system due to errors or negligence of employees or the like and information system down due to natural disasters are often reported. Furthermore, in recent years, the information systems of government agencies, companies, and other parties can be a target of a cyberattack by an actor/attacker or a criminal organization.

Under such circumstances, in order to ensure safety of information systems, it is extremely important to quickly collect accurate information regarding information security. In response to such a demand, related techniques have been provided.

For example, an information analysis device described in WO 2022/201307 A1 extracts, from a database that collects specialized information regarding cyberattacks, specialized information related to cyberattack damage information contained in news articles based on the time of occurrence of cyberattack damage.

In addition, the information analysis device described in WO 2022/201307 A1 calculates the similarity between the damage information and the specialized information in order to identify the specialized information corresponding to the damage information based on the calculated similarity. Then, the information analysis device complements the news article containing the damage information with the identified specialized information.

### SUMMARY

A large number of news articles regarding incidents and accidents related to information security are posted every day. There is a demand for a technique for integrating these news articles into one. However, some news articles include outdated information or erroneous information (including false or fake news).

The present disclosure addresses the above-described problem, and an object of the present disclosure is to determine whether the information indicated by a plurality of pieces of text data describing information security-related events is consistent with each other.

An information analysis device according to an aspect of the present disclosure includes: a memory configured to store instructions; and at least one processor configured to execute the instructions to perform: acquiring a plurality of pieces of text data describing an information security-related event; analyzing whether information indicated by the pieces of acquired text data is consistent by using information security-related knowledge information; and outputting information based on an analysis result as to whether the information indicated by the pieces of text data is consistent.

In an information analysis method according to an aspect of the present disclosure, a computer acquires a plurality of pieces of text data describing an information security-related event; analyzes whether information indicated by the pieces of acquired text data is consistent by using information security-related knowledge information; and outputs information based on an analysis result as to whether information indicated by the acquired pieces of text data is consistent.

A program according to an aspect of the present disclosure causes a computer to execute: a process of acquiring a plurality of pieces of text data describing an information security-related event; a process of analyzing whether information indicated by the pieces of acquired text data is consistent by using information security-related knowledge information; and a process of outputting information based on an analysis result as to whether information indicated by the acquired pieces of text data is consistent.

According to an aspect of the present disclosure, whether the information indicated by a plurality of pieces of text data describing an information security-related event is consistent can be determined.

### BRIEF DESCRIPTION OF THE DRAWINGS

FIG. 1 is a block diagram illustrating a configuration of an information analysis device according to an example embodiment;

FIG. 2 is a diagram illustrating examples of news articles (news articles A and B) stored in an article collection database;

FIG. 3 is a diagram illustrating an example of knowledge information stored in a knowledge information database;

FIG. 4 is a diagram illustrating an example of a prompt input to a large language model (LLM);

FIG. 5 is a diagram illustrating an example of a result output from the large language model (LLM);

FIG. 6 is a flowchart illustrating operation of an information analysis device according to an example embodiment;

FIG. 7 is a block diagram illustrating a configuration of an information analysis device according to an example embodiment;

FIG. 8 is a flowchart illustrating operation of an information analysis device according to an example embodiment;

FIG. 9 is a diagram illustrating examples of news articles (articles X, Y, and Z) collected from the Internet or the like; and

FIG. 10 is a diagram illustrating an example of a hardware configuration of an information analysis device according to an example embodiment.

### EXAMPLE EMBODIMENT

Some example embodiments of the present disclosure will be described with reference to the drawings. In the following description, “models” or "large language models (LLMs)” (sometimes referred to as natural language processing models) refer to programs (for example, generative AI) that have learned word-occurrence probabilities by extracting linguistic and contextual features from a large amount of text data by machine learning or deep learning using artificial neural network technology.

### First example embodiment

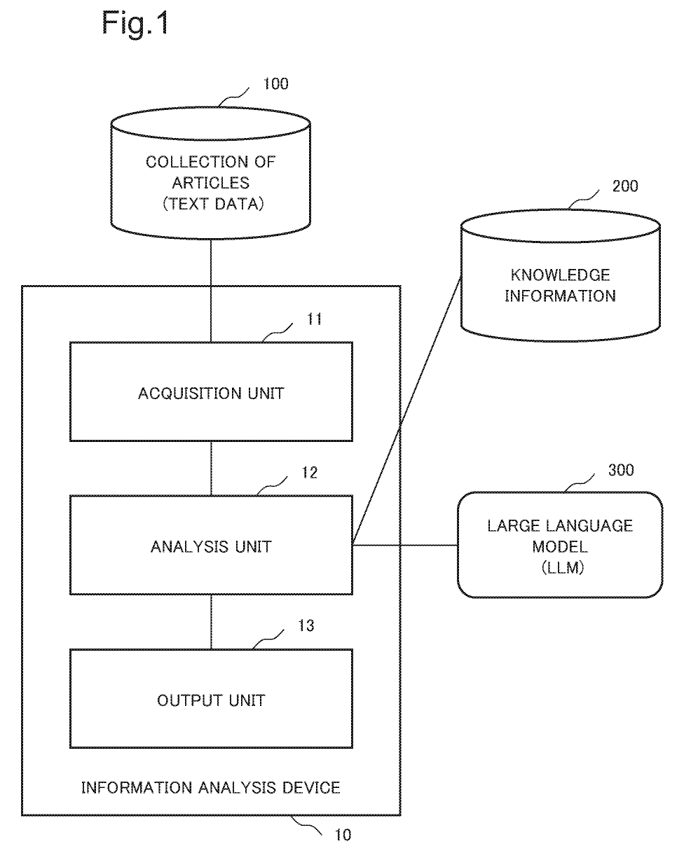

A first example embodiment will be described with reference to FIGS. 1 to 6.

### Configuration of Information analysis device 10

A configuration of an information analysis device 10 according to the first example embodiment will be described with reference to FIG. 1. FIG. 1 is a block diagram illustrating the configuration of the information analysis device 10. As illustrated in FIG. 1, the information analysis device 10 includes an acquisition unit 11, an analysis unit 12, and an output unit 13.

The acquisition unit 11 acquires a plurality of pieces of text data describing an information security-related event. The acquisition unit 11 is an example of an acquisition means.

For example, the acquisition unit 11 acquires, as the pieces of text data, a plurality of news articles related to one or more information security-related incident or accident cases from an article collection database 100. The acquisition unit 11 outputs the acquired news articles to the analysis unit 12.

Alternatively, the acquisition unit 11 may acquire a plurality of news articles related to one or more cases collected and selected in advance by the user.

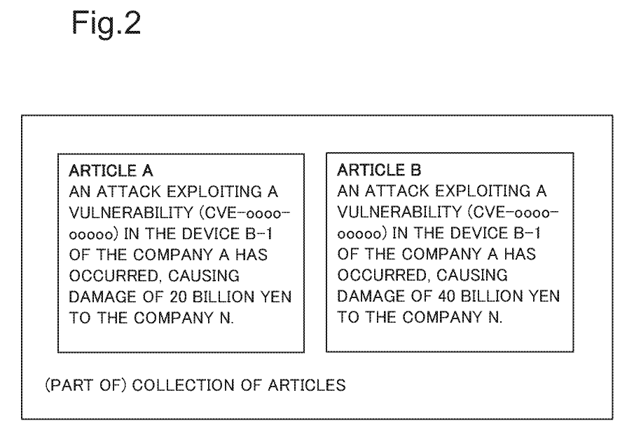

FIG. 2 illustrates examples of articles stored in the article collection database 100. The collection of articles illustrated in FIG. 2 includes a news article A, reporting “An attack exploiting a vulnerability (CVE-oooo-ooooo) in a device B-1 of a company A has occurred, causing damage of 20 billion yen to a company N”, and a news article B, reporting “An attack exploiting a vulnerability (CVE-oooo-ooooo) in the device B-1 of the company A has occurred, causing damage of 40 billion yen to the company N”. Here, CVE is an identifier (common vulnerability identifier) for identifying security weaknesses (referred to as vulnerabilities) of various software.

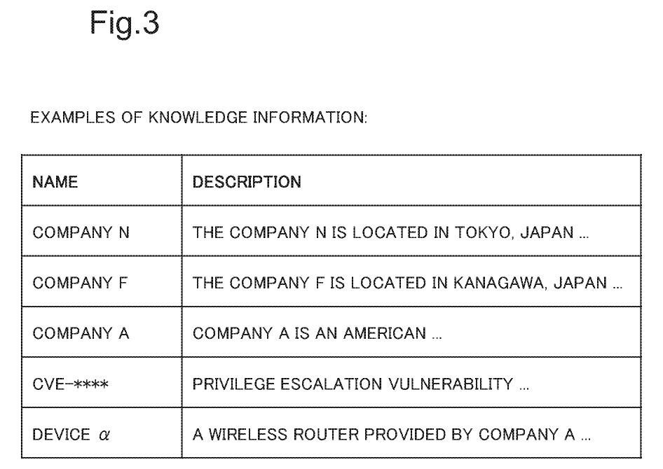

FIG. 3 is a diagram illustrating an example of knowledge information stored in a knowledge information database 200. The knowledge information indicates information that complements the content of a news article. In the example illustrated in FIG. 3, the knowledge information includes information regarding the company (“company N”, “company F”, or “company A”) that provides or uses an information device, information regarding a vulnerability (CVE-****) in an information system, and information regarding the information device (“device α”).

The analysis unit 12 acquires, from the knowledge information database 200, information associated with companies, the specifications and functions of devices, and the types of vulnerabilities respectively indicated by “company names”, “device names”, and “vulnerability identifiers” contained in each news article.

The analysis unit 12 analyzes whether the information indicated by the pieces of text data is consistent, in other words, whether there is no contradiction, by using the knowledge information related to information security. The analysis unit 12 is an example of an analysis means.

In one example, the analysis unit 12 inputs the content of a plurality of news articles acquired by the acquisition unit 11 or a part thereof (for example, the main body, summary, or title) and knowledge information complementing the content of each news article to a large language model 300.

Then, the analysis unit 12 causes the large language model 300 to determine whether the content of the input news articles, that is, the information is consistent. In one example, the analysis unit 12 inputs, to the large language model 300, an instruction text to determine “whether the article B can be considered correct given that the article A is correct”. Here, the content of the news articles specifically refers to the “main body”, “summary”, and “title” of each news article. Each news article includes “company names”, a “device name,” and a “vulnerability identifier” (see FIG. 2).

The analysis unit 12 generates an instruction text for giving instructions to the large language model 300. Then, the analysis unit 12 inputs a prompt including the generated instruction text to the large language model 300. An example of the prompt will be described later.

In another example, the analysis unit 12 causes the large language model 300 to summarize the content of a plurality of news articles (an example of text data), and then causes the large language model 300 to determine whether the summaries of the news articles are consistent with each other. Alternatively, instead of summarizing a plurality of news articles, the analysis unit 12 may input the title of each news article to the large language model 300. Alternatively, as in a modification described later, instead of inputting an instruction text into the large language model 300, the analysis unit 12 can determine whether the content of a plurality of news articles (an example of text data) is consistent based on a “first feature word” indicating the cause of an information security-related event and a “second feature word” indicating the result of an information security-related event. Specific examples of the “first feature word” and the “second feature word” will be described later.

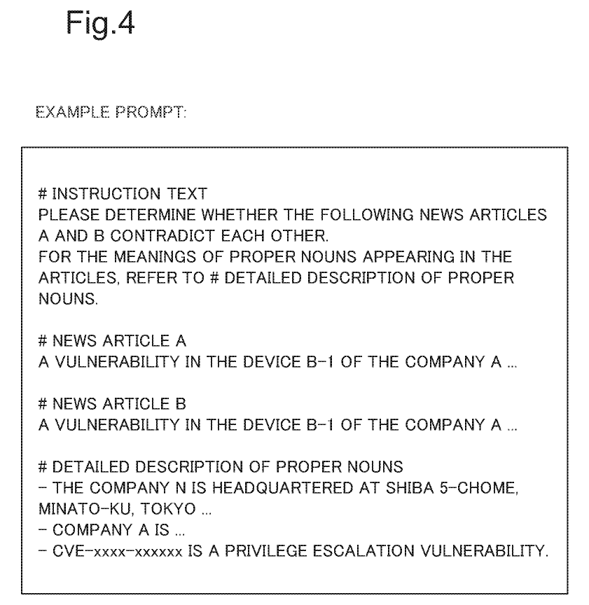

FIG. 4 illustrates an example of a prompt input by the analysis unit 12 to the large language model 300. In the example illustrated in FIG. 4, an instruction text such as the following is included in the prompt: "Please determine whether the following news articles A and B contradict each other. For the meanings of proper nouns appearing in the articles, refer to # Detailed Description of Proper Nouns". Here, “# Detailed Description of Proper Nouns” in the instruction text means the knowledge information.

Furthermore, the prompt illustrated in FIG. 4 includes the main body (or summary or title) of the news articles A and B. In addition, the prompt illustrated in FIG. 4 includes the knowledge information associated with the “company names”, “device name”, and “vulnerability identifier” appearing in the main body of the news articles A and B.

The large language model 300 uses the main body of the news articles A and B included in the prompt and the knowledge information to determine whether the content of the input news articles is consistent, following the instruction text of the given prompt, and outputs the determination result.

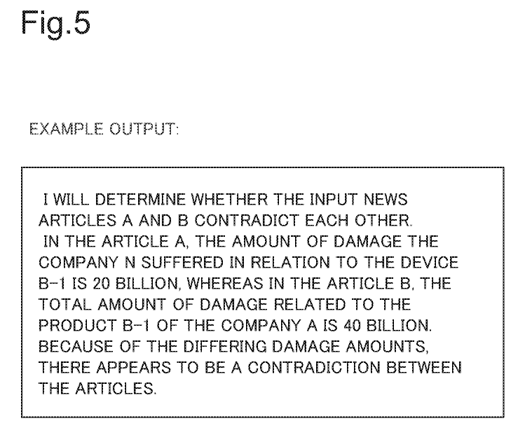

FIG. 5 shows an example output from the large language model 300. As illustrated in FIG. 5, the large language model 300 outputs a text such as the following: "I will determine whether the input news articles A and B contradict each other. In the news article A, the amount of damage the company N suffered in relation to the device B-1 is 20 billion yen, whereas in the news article B, the total amount of damage related to the product B-1 of the company A is 40 billion yen. Because of the differing damage amounts (20 billion yen vs 40 billion yen), there appears to be a contradiction between the articles".

The analysis unit 12 acquires the determination result (FIG. 5) output from the large language model 300. The analysis unit 12 determines whether the content of the news articles match based on the determination result output from the large language model 300. Note that, as in a modification to be described later, the analysis unit 12 can also determine whether the content of a plurality of news articles is consistent without relying on the large language model 300.

For example, the analysis unit 12 determines whether the content of each news article is correct based on a determination result output from the large language model 300.

If there are two or more news articles whose content has been analyzed to be inconsistent, the analysis unit 12 determines one or more news articles whose content is correct from the two or more news articles.

In one example, the analysis unit 12 determines that the content of the news article having the latest timestamp is correct among the two or more news articles.

In another example, the analysis unit 12 determines that the content that is consistent across the largest number of news articles is correct among two or more news articles. In still another example, the analysis unit 12 determines that content of a more reliable news article is correct based on a predefined reliability of each news site or a predefined reliability of each medium.

The analysis unit 12 outputs the determination result as to whether the content of each news article is correct to the output unit 13. Alternatively, the analysis unit 12 may simply output, to the output unit 13, a result of determination by the large language model 300 as to whether the content of the news articles is consistent. The large language model 300 is an example of a "model”. In the following description of the present disclosure, instead of the large language model 300, another computer program (referred to as a language model) for text data analysis may also be utilized.

The output unit 13 receives, from the analysis unit 12, the determination result as to whether the content of each of the news articles (examples of a plurality of pieces of text data) is correct. Then, the output unit 13 outputs information based on the analysis result as to whether the content of the news articles is consistent.

For example, the output unit 13 outputs only the news articles whose content is determined to be correct by the analysis unit 12 among the analyzed news articles.

In another example, the output unit 13 outputs information indicating whether the content of the news articles is consistent.

In still another example, when the content of the news articles is consistent, the output unit 13 outputs an outline of the information indicated by the news articles.

### Modifications

In a case where the main body of a news article (an example of text data) is short, or in a case where the analysis target is the summary or title of a news article, the amount of information to be analyzed is small. In such a case, a similarity indicating how similar the features of a plurality of news articles are can be used to analyze whether their content is consistent.

In one modification, instead of using the large language model 300, the analysis unit 12 calculates a feature similarity between a plurality of news articles A and B (FIG. 2). Then, the analysis unit 12 may determine whether their content is consistent based on whether the magnitude of the calculated similarity exceeds a predetermined threshold.

According to the configuration of the present modification, the analysis unit 12 can determine whether the content of a plurality of news articles is consistent without using the large language model 300 (FIG. 1).

In another modification, the analysis unit 12 extracts a first feature word representing a cause of an information security-related event and a second feature word representing a result of the information security-related event from each news article. The analysis unit 12 compares the first feature words with each other and the second feature words with each other extracted from the news articles, and analyzes whether both the first and second feature words are consistent.

Here, the content of a plurality of news articles (an example of information indicated by text data) being consistent means that both of the first feature word representing a cause of an information security-related event (for example, “power outage”, “mistaken e-mail transmission”, and “cyberattack”) and the second feature word representing a result of the information security-related event (for example, “information leakage”, “system down”, “ransom demand”, and “scale or amount of damage”) are consistent among the news articles. Note that a list of the first and second feature words indicating causes/results of information security-related events is taught to the large language model 300 in advance.

### Operation Of Information Analysis Device 10

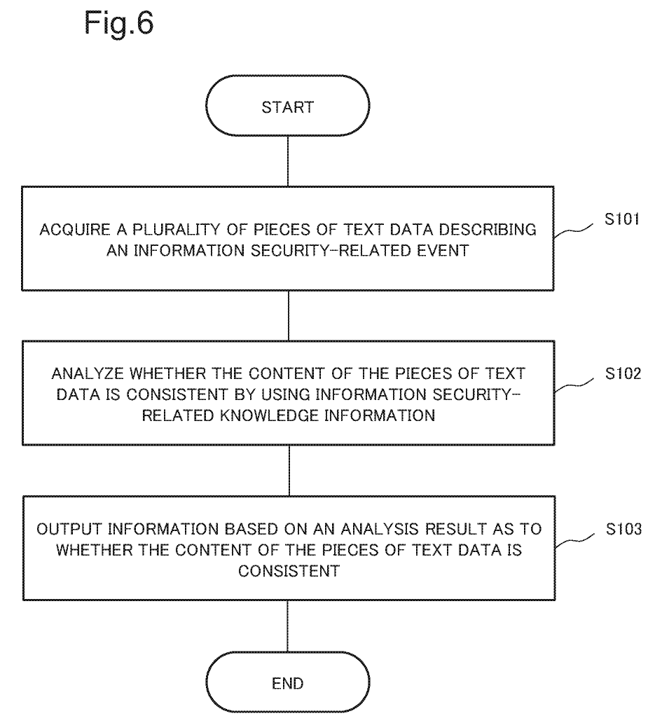

Operation of the information analysis device 10 according to the first example embodiment will be described with reference to FIG. 6. FIG. 6 is a flowchart illustrating the operation of the information analysis device 10.

As illustrated in FIG. 6, first, the acquisition unit 11 acquires a plurality of pieces of text data (for example, news articles) related to an information security-related event (an accident of incident, or an accident prevented before occurrence related to information security) (S101). The acquisition unit 11 outputs the acquired text data to the analysis unit 12.

Next, the analysis unit 12 analyzes whether the information indicated by the pieces of text data (for example, the content of the news articles) is consistent by using information security-related knowledge information (S102). The analysis unit 12 outputs to the output unit 13 an analysis result as to whether the information indicated by the pieces of text data is consistent.

Finally, the output unit 13 outputs information (for example, a news article whose content is determined to be correct) based on the analysis result as to whether the information indicated by the pieces of text data is consistent (S103).

Thus, the operation of the information analysis device 10 ends.

### Effects Of Present Example Embodiment

According to the configuration of the present example embodiment, the acquisition unit 11 acquires a plurality of pieces of text data describing an information security-related event. The analysis unit 12 analyzes whether the information indicated by the pieces of text data is consistent by using the knowledge information related to information security. The output unit 13 outputs information based on an analysis result as to whether the information indicated by the pieces of text data is consistent.

As a result, even in a case where some of the pieces of text data contain old information or wrong information, it is possible to find a piece of text data that is not consistent with the other pieces of text data by determining whether the information indicated by the pieces of text data is consistent.

### Second Example Embodiment

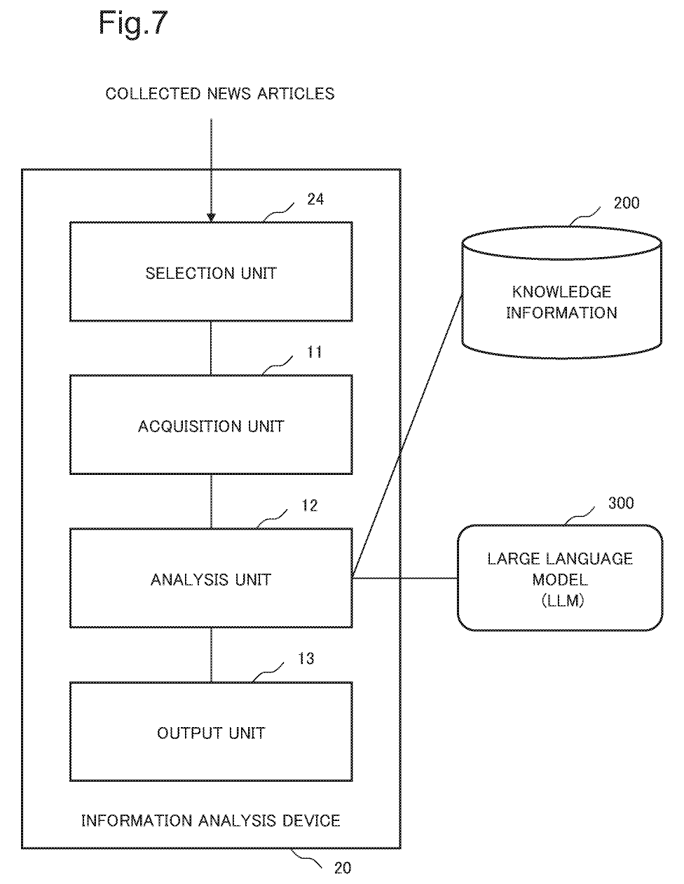

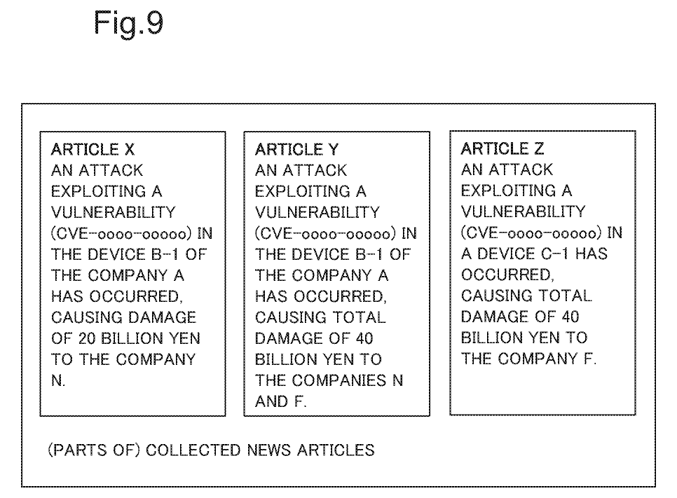

A second example embodiment of the present disclosure will be described with reference to FIGS. 7 to 9. In the first example embodiment, the news articles A and B (FIG. 2) are not necessarily associated with the same information security-related incident or accident case. The second example embodiment describes a configuration for selecting, from collected news articles X, Y, and Z (FIG. 9), articles of the same information security-related incident or accident case.

In the second example embodiment, the same components as those in the first example embodiment are denoted by the same reference numerals as those in the first example embodiment, and the description thereof will be omitted.

### Configuration Of Information Analysis Device 20

A configuration of an information analysis device 20 according to the second example embodiment will be described with reference to FIG. 7. FIG. 7 is a block diagram illustrating a configuration of the information analysis device 20.

As illustrated in FIG. 7, the information analysis device 20 includes the acquisition unit 11, the analysis unit 12, the output unit 13, and a selection unit 24.

The selection unit 24 selects a plurality of pieces of text data related to the same information security-related incident or accident (an example of an information security-related event) from the collected text data. The selection unit 24 is an example of a selection means.

For example, the selection unit 24 collects arbitrary news articles (examples of text data) on the Internet or from a server. Then, the selection unit 24 extracts specific keywords from each of the collected news articles using a text analysis technology. The specific keywords here are “company name”, “device name”, and “vulnerability identifier (or type)”.

The selection unit 24 determines whether all the specific keywords (“company name”, “device name”, and “vulnerability identifier (or type)”) extracted from the collected news articles match with each other. Note that, in a case where a plurality of company names and a plurality of device names are included in a news article, it is determined whether all the company names and all the device names match among the collected news articles.

Alternatively, the selection unit 24 can also use the large language model 300 (an example of a “selection model”) to select a plurality of pieces of text data associated with the same information security-related incident or accident case. For example, the selection unit 24 inputs, to the large language model 300, a prompt containing an instruction text to determine news articles of the same information security-related incident or accident case, the main body of each news article to be determined, and the meaning of unique information included in the news articles to be determined. Then, the selection unit 24 acquires the determination result output from the large language model 300. In another example, the selection unit 24 calculates the similarity between a plurality of pieces of text data, and determines that pieces of text data having a similarity higher than a certain threshold are related to the same information security-related incident or accident case.

The selection unit 24 selects a plurality of news articles in which all the extracted specific keywords match. Then, the selection unit 24 outputs the selected news articles to the acquisition unit 11 as being associated with the same information security-related incident or accident case.

The acquisition unit 11 acquires, from the selection unit 24, the plurality of news articles selected as being associated with the same information security-related incident or accident case. Then, as in the first example embodiment, the acquisition unit 11 outputs the text data of the acquired news articles to the analysis unit 12.

### Operation Of Information Analysis Device 20

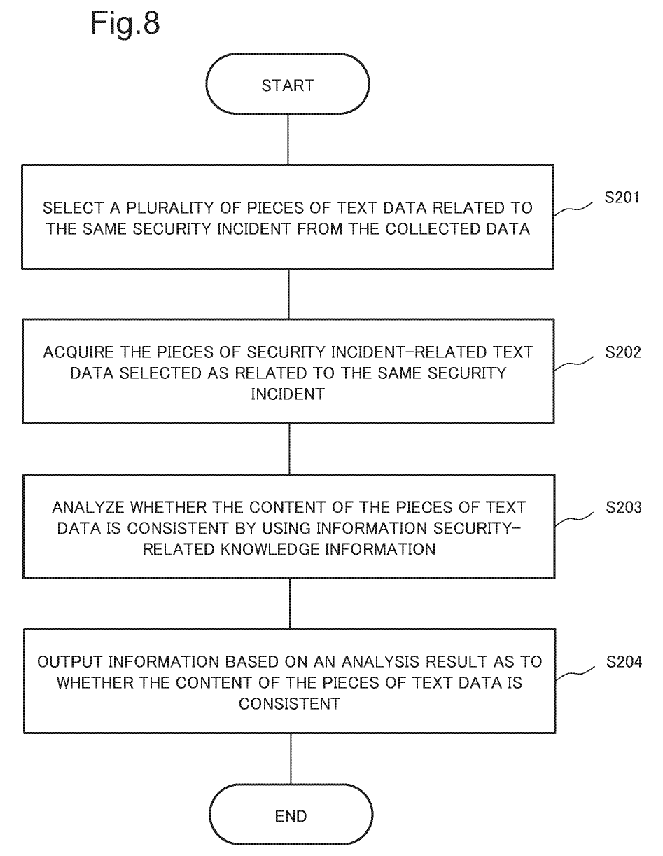

Operation of the information analysis device 20 according to the second example embodiment will be described with reference to FIG. 8. FIG. 8 is a flowchart illustrating the operation of the information analysis device 20.

As shown in FIG. 8, first, the selection unit 24 selects a plurality of pieces of text data (for example, news articles) related to the same information security-related incident or accident case (an example of an information security-related event) from text data collected, for example, from the Internet (S201). The selection unit 24 outputs the selected pieces of text data to the acquisition unit 11.

Next, the acquisition unit 11 acquires a plurality of pieces of text data describing an information security-related event (S202). The acquisition unit 11 outputs the acquired text data to the analysis unit 12.

Next, the analysis unit 12 analyzes whether the information indicated by the pieces of text data (for example, the content of the news articles) is consistent by using information security-related knowledge information (S203). The analysis unit 12 outputs to the output unit 13 an analysis result as to whether the information indicated by the pieces of text data is consistent.

Finally, the output unit 13 outputs information (for example, a news article whose content is determined to be correct) based on the analysis result as to whether the information indicated by the pieces of text data is consistent (S204).

Thus, the operation of the information analysis device 20 ends.

### Effects Of Present Example Embodiment

According to the present example embodiment, the selection unit 24 selects a plurality of pieces of text data related to the same information security-related incident or accident case from the collected text data. The acquisition unit 11 acquires the pieces of text data selected as being associated with the same information security-related incident or accident case. The analysis unit 12 analyzes whether the information indicated by the pieces of text data is consistent by using the knowledge information related to information security. The output unit 13 outputs information based on an analysis result as to whether the information indicated by the pieces of text data is consistent.

As a result, even in a case where some of the pieces of text data contain old information or wrong information, it is possible to find a piece of text data that is not consistent with the other pieces of text data by determining whether the information indicated by the pieces of text data is consistent.

### Hardware Configuration

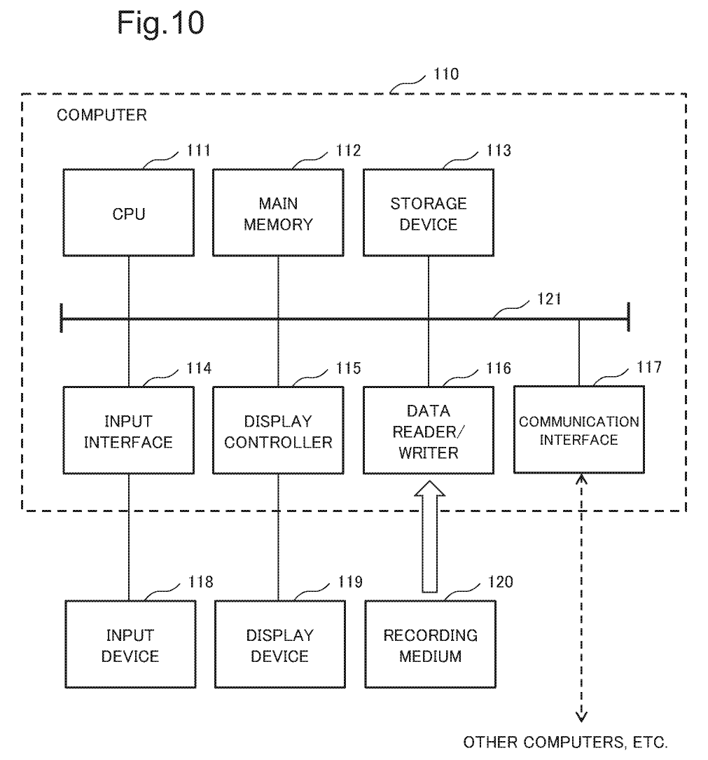

Each component of the information analysis devices 10 and 20 described in the first and second example embodiments represents a block of a functional unit. Part or all of these components is achieved by, for example, an information processing device as illustrated in FIG. 10. FIG. 10 is a block diagram illustrating an example of a hardware configuration of an information processing device.

As illustrated in FIG. 10, a computer 110 includes a central processing unit (CPU) 111, a main memory 112, a storage device 113, an input interface 114, a display controller 115, a data reader/writer 116, and a communication interface 117. These units are connected via a bus 121 in such a way as to be able to perform data communication with each other. The computer 110 may include a graphics processing unit (GPU) or a field-programmable gate array (FPGA) in addition to the CPU 111 or instead of the CPU 111.

The CPU 111 loads the programs (codes) in the present example embodiment, which are stored in the storage device 113, into the main memory 112, and executes them in a predetermined order to perform various operations. The main memory 112 is typically a volatile storage device such as a dynamic random access memory (DRAM). The programs in the present example embodiment are provided in a state of being stored in a computer-readable recording medium 120. The programs in the present example embodiment may be distributed on the Internet connected via the communication interface 117.

Specific examples of the storage device 113 include a semiconductor storage device, such as a flash memory, in addition to a hard disk drive. The input interface 114 mediates data transmission between the CPU 111 and an input device 118 such as a keyboard and a mouse. The display controller 115 is connected to a display device 119 and controls display on the display device 119.

The data reader/writer 116 mediates data transmission between the CPU 111 and the recording medium 120, and reads a program from the recording medium 120 and writes a processing result in the computer 110 to the recording medium 120. The communication interface 117 mediates data transmission between the CPU 111 and another computer.

Specific examples of the recording medium 120 include a general-purpose semiconductor storage device such as Compact Flash (CF) (registered trademark) or Secure Digital (SD), a magnetic recording medium such as a flexible disk, and an optical recording medium such as a compact disk read only memory (CD-ROM).

### Supplementary Note

Some or all of the above example embodiments can also be described as the following Supplementary Notes, but are not limited to the following.

### Supplementary Note 1

An information analysis device including:

an acquisition means for acquiring a plurality of pieces of text data describing an information security-related event;

an analysis means for analyzing whether information indicated by the pieces of acquired text data is consistent by using information security-related knowledge information; and

an output means for outputting information based on an analysis result as to whether information indicated by the acquired pieces of text data is consistent.

### Supplementary Note 2

The information analysis device according to Supplementary Note 1, wherein

the acquisition means acquires, as the pieces of text data, a plurality of news articles related to one or more information security-related incident or accident cases.

### Supplementary Note 3

The information analysis device according to Supplementary Note 1 or 2, wherein

the analysis means

inputs the pieces of text data or a part thereof into a model, and

causes the model to determine whether the information indicated by the pieces of text data is consistent.

### Supplementary Note 4

The information analysis device according to Supplementary Note 3, wherein

the analysis means

inputs knowledge information related to the pieces of text data or the part thereof into the model, together with the pieces of text data or the part thereof, and

causes the model to determine whether the information indicated by the pieces of text data is consistent.

### Supplementary Note 5

The information analysis device according to Supplementary Note 3, wherein

the analysis means causes the model to summarize the information indicated by the pieces of text data, and then causes the model to determine whether a summary of the information indicated by the pieces of text data is consistent.

### Supplementary Note 6

The information analysis device according to Supplementary Note 5, wherein

the analysis means inputs a title of each of the pieces of text data to the model.

### Supplementary Note 7

The information analysis device according to any one of Supplementary Notes 1 to 6, wherein,

when the information indicated by the pieces of text data is not consistent, the analysis means determines one or more pieces of text data indicating correct information among the pieces of text data.

### Supplementary Note 8

The information analysis device according to Supplementary Note 7, wherein

the analysis means determines, among the pieces of text data, a piece of text data having the latest timestamp as a piece of text data indicating correct information.

### Supplementary Note 9

The information analysis device according to Supplementary Note 7, wherein

the analysis means determines, among the pieces of text data, a piece of text data indicating information that is consistent across the largest number of pieces of text data as a piece of text data indicating correct information.

### Supplementary Note 10

The information analysis device according to any one of Supplementary Notes 1 to 9, wherein

the output means outputs information indicating whether the information indicated by the pieces of text data is consistent.

### Supplementary Note 11

The information analysis device according to any one of Supplementary Notes 1 to 9, wherein,

when the information indicated by the pieces of text data is consistent, the output means outputs an outline of the information indicated by the pieces of text data.

### Supplementary Note 12

The information analysis device according to any one of Supplementary Notes 1 to 11, further including

a selection means for selecting a plurality of pieces of text data related to the same information security-related incident or accident case from collected pieces of text data, wherein

the acquisition means acquires the pieces of text data selected as being related to the same information security-related incident or accident case.

### Supplementary Note 13

The information analysis device according to Supplementary Note 12, wherein

the selection means

inputs the collected pieces of text data or a part thereof into a selection model, and

causes the selection model to determine whether the collected pieces of text data are related to the same information security-related incident or accident case.

### Supplementary Note 14

The information analysis device according to Supplementary Note 13, wherein

the selection means

inputs knowledge information related to the pieces of text data or the part thereof into the selection model, together with the pieces of text data or the part thereof, and

causes the selection model to determine whether the collected pieces of text data are related to the same information security-related incident or accident case by using the knowledge information.

### Supplementary Note 15

The information analysis device according to Supplementary Note 12, wherein,

when a specific keyword is shared by different pieces of text data, the selection means determines that the different pieces of text data are related to the same information security-related incident or accident case.

### Supplementary Note 16

The information analysis device according to Supplementary Note 15, wherein

the specific keyword includes at least a company name, a vulnerability type, and a device name.

### Supplementary Note 17

An information analysis method executed by a computer, the information analysis method including:

acquiring a plurality of pieces of text data describing an information security-related event;

analyzing whether information indicated by the pieces of acquired text data is consistent by using information security-related knowledge information; and

outputting information based on an analysis result as to whether information indicated by the acquired pieces of text data is consistent.

### Supplementary Note 18

A program that causes a computer to execute:

a process of acquiring a plurality of pieces of text data describing an information security-related event;

a process of analyzing whether information indicated by the pieces of acquired text data is consistent by using information security-related knowledge information; and

a process of outputting information based on an analysis result as to whether information indicated by the acquired pieces of text data is consistent.

### Supplementary Note 19

The information analysis device according to Supplementary Note 1 or 2, wherein

the analysis means

extracts a first feature word representing a cause of an information security-related incident or accident, and a second feature word representing a result of the information security-related incident or accident from each of the pieces of text data, and

compares the first feature words with each other and the second feature words with each other extracted from the pieces of text data to analyze whether both the first and second feature words are consistent.

Some or all of the configurations described in Supplementary Notes 2 to 16 and 19 dependent on the above-described Supplementary Note 1 can be dependent on Supplementary Notes 17 or 18 by the same dependency relationship as that of Supplementary Notes 2 to 16 and 19. Some or all of the configurations described as Supplementary Notes can be similarly dependent on various hardware, software, recording means for recording software, or systems without departing from the above-described example embodiments.

The present disclosure has been described above with reference to several example embodiments. However, the present disclosure is not limited to the above example embodiments. Each example embodiment can be appropriately combined with other example embodiments. Various modifications, which can be understood by those skilled in the art, can be made to the configuration and details of the above example embodiments within the scope of the present disclosure.

The present disclosure can be used, for example, in information analysis technologies for analyzing text data such as news articles.

1. An information analysis device comprising:
a memory configured to store instructions; and
at least one processor configured to execute the instructions to perform:
acquiring a plurality of pieces of text data describing an information security-related event;
analyzing whether information indicated by the pieces of acquired text data is consistent by using information security-related knowledge information; and
outputting information based on an analysis result as to whether the information indicated by the pieces of text data is consistent.

2. The information analysis device according to claim 1, wherein
the at least one processor is configured to execute the instructions to perform acquiring, as the pieces of text data, a plurality of news articles related to one or more information security-related incident or accident cases.

3. The information analysis device according to claim 1, wherein
the at least one processor is configured to execute the instructions to perform:
inputting the pieces of text data or a part thereof into a model, and
causing the model to determine whether the information indicated by the pieces of text data is consistent.

4. The information analysis device according to claim 3, wherein
the at least one processor is configured to execute the instructions to perform:
inputting knowledge information related to the pieces of text data or the part thereof into the model, together with the pieces of text data or the part thereof, and
causing the model to determine whether the information indicated by the pieces of text data is consistent.

5. The information analysis device according to claim 3, wherein
the at least one processor is configured to cause the model to summarize the information indicated by the pieces of text data, and then causes the model to determine whether a summary of the information indicated by the pieces of text data is consistent.

6. The information analysis device according to claim 5, wherein
the at least one processor is configured to execute the instructions to perform inputting a title of each of the pieces of text data to the model.

7. The information analysis device according to claim 1, wherein,
the at least one processor is configured to execute the instructions to perform
when the information indicated by the pieces of text data is not consistent, the determining one or more pieces of text data indicating correct information among the pieces of text data.

8. The information analysis device according to claim 7, wherein
the at least one processor is configured to execute the instructions to perform determining, among the pieces of text data, a piece of text data having the latest timestamp as a piece of text data indicating correct information.

9. The information analysis device according to claim 7, wherein
the at least one processor is configured to execute the instructions to perform determining, among the pieces of text data, a piece of text data indicating information that is consistent across the largest number of pieces of text data as a piece of text data indicating correct information.

10. The information analysis device according to claim 1, wherein
the at least one processor is configured to execute the instructions to perform outputting information indicating whether the information indicated by the pieces of text data is consistent.

11. The information analysis device according to claim 1, wherein,
the at least one processor is configured to execute the instructions to perform
when the information indicated by the pieces of text data is consistent, outputting an outline of the information indicated by the pieces of text data.

12. The information analysis device according to claim 1, wherein
the at least one processor is further configured to execute the instructions to perform
selecting a plurality of pieces of text data related to the same information security-related incident or accident case from collected pieces of text data, and wherein
the at least one processor is configured to execute the instructions to perform acquiring the pieces of text data selected as being related to the same information security-related incident or accident case.

13. The information analysis device according to claim 12, wherein
the at least one processor is configured to execute the instructions to perform:
inputting the collected pieces of text data or a part thereof into a selection model, and
causing the selection model to determine whether the collected pieces of text data are related to the same information security-related incident or accident case.

14. The information analysis device according to claim 13, wherein
the at least one processor is configured to execute the instructions to perform:
inputting knowledge information related to the pieces of text data or the part thereof into the selection model, together with the pieces of text data or the part thereof, and
causing the selection model to determine whether the collected pieces of text data are related to the same information security-related incident or accident case by using the knowledge information.

15. The information analysis device according to claim 12, wherein,
the at least one processor is configured to execute the instructions to perform:
when a specific keyword is shared by different pieces of text data, determining that the different pieces of text data are related to the same information security-related incident or accident case.

16. The information analysis device according to claim 15, wherein
the specific keyword includes at least a company name, a vulnerability type, and a device name.

17. An information analysis method executed by a computer, the information analysis method comprising:
acquiring a plurality of pieces of text data describing an information security-related event;
analyzing whether information indicated by the pieces of acquired text data is consistent by using information security-related knowledge information; and
outputting information based on an analysis result as to whether the information indicated by the pieces of text data is consistent.

18. A non-transitory recording medium storing a program for causing a computer to execute:
a process of acquiring a plurality of pieces of text data describing an information security-related event;
a process of analyzing whether information indicated by the pieces of acquired text data is consistent by using information security-related knowledge information; and
a process of outputting information based on an analysis result as to whether the information indicated by the pieces of text data is consistent.
